(19) United States
(12) Patent Application Publication
(10) Pub. No.: US 2010/0180154 A1
(43) Pub. Date: Jul. 15, 2010

(54) Built In Self-Test of Memory Stressor

(75) Inventor: Mark D. Bellows, Rochester, MN (US)

Correspondence Address: CANTOR COLBURN LLP-IBM POUGHKEEPSIE, 20 Church Street, 22nd Floor, Hartford, CT, 06103, US

(73) Assignee: INTERNATIONAL BUSINESS MACHINES CORPORATION, Armonk, NY (US)

(21) Appl. No.: 12/352,633

(22) Filed: Jan. 13, 2009

(51) Int. Cl. G06F 11/00

(52) U.S. Cl. 714/30; 714/E11.002

(57) ABSTRACT

A method and system for generating addresses in a memory card built in self-test (MCBIST) for testing memory devices. The method includes receiving a MCBIST command and determining an addressing mode of the MCBIST command. Sequential addresses are generated and modified in response to the addressing mode being a stress test mode. The modifying includes swapping bits in a sequential address with other bits in the sequential address to target selected portions of a memory. The modified sequential addresses are output to the memory to be utilized in a MCBIST stress test of the memory.

### BACKGROUND

This invention relates generally to computer memory systems, and more particularly to providing a built in self-test (BIST) memory stressor capability.

Contemporary high performance computing main memory systems are generally composed of one or more dynamic random access memory (DRAM) devices, which are connected to one or more processors via one or more memory control elements. Overall computer system performance is affected by each of the key elements of the computer structure, including the performance/structure of the processor(s), any memory cache(s), the input/output (I/O) subsystem(s), the efficiency of the memory control function(s), the main memory device(s), and the type and structure of the memory interconnect interface(s).

Extensive research and development efforts are invested by the industry, on an ongoing basis, to create improved and/or innovative solutions to maximizing overall system performance and density by improving the memory system/subsystem design and/or structure. High-availability systems present further challenges as related to overall system reliability due to customer expectations that new computer systems will markedly surpass existing systems in regard to mean-time-between-failure (MTBF), in addition to offering additional functions, increased performance, increased storage, lower operating costs, etc. Other frequent customer requirements further exacerbate the memory system design challenges, and include such items as ease of upgrade and reduced system environmental impact (such as space, power and cooling).

### SUMMARY

An exemplary embodiment is a method for generating addresses in a memory card built in self-test (MCBIST) for testing memory devices. The method includes receiving a MCBIST command and determining an addressing mode of the MCBIST command. Sequential addresses are generated and modified in response to the addressing mode being a stress test mode. The modifying includes swapping bits in a sequential address with other bits in the sequential address to target selected portions of a memory. The modified sequential addresses are output to the memory to be utilized in a MCBIST stress test of the memory.

Another exemplary embodiment is a system for generating addresses in a MCBIST for testing memory devices. The system includes MCBIST logic for receiving a MCBIST command and for determining an addressing mode of the MCBIST command. The system also includes an address generator for generating sequential addresses in response to the addressing mode being a stress test mode. The system further includes a mapper for modifying the sequential addresses in response to the addressing mode being a stress test mode. The modifying includes swapping bits in a sequential address with other bits in the sequential address to target selected portions of a memory. The system further includes a transmitter for outputting the modified sequential addresses to the memory to be utilized in a MCBIST stress test of the memory.

A further exemplary embodiment is a hub device that includes an interface to a high speed bus for communicating with a memory controller. The memory controller and the hub device are included in a cascade interconnect memory system, with the hub device receiving MCBIST commands from the memory controller. The hub device also includes MCBIST logic for receiving the MCBIST command and for determining an addressing mode of the MCBIST command. The hub device also includes an address generator for generating sequential addresses in response to the addressing mode being a stress test mode. The hub device further includes a mapper for modifying the sequential addresses in response to the addressing mode being a stress test mode. The modifying includes swapping bits in a sequential address with other bits in the sequential address to target selected portions of a memory. The hub device further includes a transmitter for outputting the modified sequential addresses to the memory to be utilized in a MCBIST stress test of the memory.

A still further embodiment is a design structure tangible embodied in a machine readable medium for designing, manufacturing, or testing an integrated circuit. The design structure includes MCBIST logic for receiving a MCBIST command and for determining an addressing mode of the MCBIST command. The design structure also includes an address generator for generating sequential addresses in response to the addressing mode being a stress test mode. The design structure further includes a mapper for modifying the sequential addresses in response to the addressing mode being a stress test mode. The modifying includes swapping bits in a sequential address with other bits in the sequential address to target selected portions of a memory. The design structure further includes a transmitter for outputting the modified sequential addresses to the memory to be utilized in a MCBIST stress test of the memory.

Other systems, methods, and/or computer program products according to embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE SEVERAL VIEWS OF THE DRAWINGS

Referring now to the drawings wherein like elements are numbered alike in the several FIGURES:

FIG. 1 depicts a cascade interconnect memory system that may be implemented by an exemplary embodiment;

FIG. 2 is a block diagram of a high-level logic flow of a hub device that may be implemented by an exemplary embodiment;

FIG. 3 is a block diagram of a memory card built in self-test (MCBIST) functional block that may be implemented by an exemplary embodiment;

FIG. 4 is a process flow that may by implemented to provide programmable MCBIST capability in an exemplary embodiment; and

FIG. 5 shows a block diagram of a design flow that may be implemented by an exemplary embodiment.

### DETAILED DESCRIPTION

Exemplary embodiments of the present invention provide a programmable addressing mechanism utilized by a memory card built in self-test (MCBIST) process for stressing memory device hardware such that soft failures can be observed.

Because of memory speed and board layouts, a memory system typically includes self-test mechanisms to test memory cells. A dedicated function may be built into the memory system so that the testing of memory devices can be performed. These self-test mechanisms (e.g., MCBISTs, BISTs) usually do not contain complicated hardware because they must fit on the system and are typically only used during manufacturing or system diagnostic checking. Because of the space constraints, MCBISTs typically only provide two modes of addressing: sequential and pseudo random. Sequential addressing can include forward sequential addresses or backward sequential addresses. In addition, sequential addressing may be applied to specified address ranges. Random addressing typically uses a sequence of addresses in what appears to be a random pattern. In addition, MCBISTs also contain methods for running multiple test sequences to read and write the memory components, and schemes for generating and checking data.

Sequential and pseudo random addressing may fail to stress the hardware such that certain types of soft failures can be observed. Sequential addressing may be efficient in terms of accessing as many banks and cells as possible, but it may miss special sequences that would be useful in finding defective memory cells. Pseudo random addressing may also not hit a failing sequence of addresses. Exemplary embodiments described herein provide a third mode of addressing that may be utilized to perform stress testing of a memory device. For example, exemplary embodiments may be utilized to generate memory addresses that stress memory cells within a particular row and/or to stress memory cells within a particular column on a memory device.

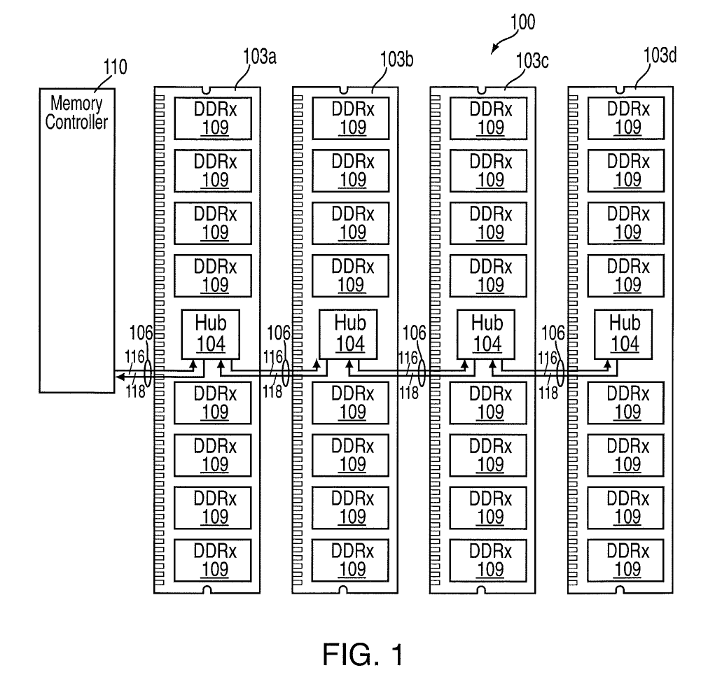

Turning now to FIG. 1, an example of a memory system 100 that includes fully buffered DIMMs communicating via a high-speed channel and using the programmable MCBIST described herein. The memory system 100 may be incorporated in a host processing system as main memory for the processing system. The memory system 100 includes a number of DIMMs 103a, 103b, 103c and 103d with memory hub devices 104 communicating via a channel 106 or a cascade-interconnected bus (made up of a differential unidirectional upstream bus 118 and a differential unidirectional downstream bus 116). The DIMMs 103a-103d can include multiple memory devices 109, which may be double data rate (DDR) dynamic random access memory (DRAM) devices, as well as other components known in the art, e.g., resistors, capacitors, etc. The memory devices 109 are also referred to as DRAM 109 or DDRx 109, as any version of DDR may be included on the DIMMs 103a-103d, e.g., DDR2, DDR3, DDR4, etc.

The memory devices 109 attached to a DIMM 103a-103d may be arranged as two or more banks of memory and/or as two or more ranks of memory. Thus, in an exemplary embodiment a memory device address includes bits that specify a particular bank and/or rank. In addition, in an exemplary embodiment, each cell in a memory device is individually addressable based on its column and row location within the memory device.

A memory controller 110 interfaces with DIMM 103a, sending commands, address and data values via the channel 106 that may target any of the DIMMs 103a-103d. The commands, address and data values may be formatted as frames and serialized for transmission at a high data rate. In an exemplary embodiment, when a DIMM receives a frame from an upstream DIMM or the memory controller 110, it redrives the frame to the next DIMM in the daisy chain (e.g., DIMM 103a redrives to DIMM 103b, DIMM 103b redrives to DIMM 103c, etc.). At the same time, the DIMM decodes the frame to determine the contents. Thus, the redrive and command decode at a DIMM can occur in parallel, or nearly in parallel. If the command is a read request, all DIMMS 103a-103d and the memory controller 110 utilize contents of the command to keep track of read data traffic on the upstream bus 118.

The hub devices 104 on the DIMMs receive commands via a bus interface (e.g. a port) to the channel 106. The bus interface on the hub device 104 includes, among other components, a receiver and a transmitter. In an exemplary embodiment, a hub device 104 includes both an upstream bus interface for communicating with an upstream hub device 104 or memory controller 110 via the channel 106 and a downstream bus interface for communicating with a downstream hub device 104 via the channel 106.

Although only a single memory channel 106 is shown in FIG. 1 connecting the memory controller 110 to a single memory device hub 104, systems produced with these modules may include more than one discrete memory channel from the memory controller, with each of the memory channels operated singly (when a single channel is populated with modules) or in parallel (when two or more channels are populated with modules) to achieve the desired system functionality and/or performance. Moreover, any number of lanes can be included in the channel 106. For example, the downstream bus 116 can include 13 bit lanes, 2 spare lanes and a clock lane, while the upstream bus 118 may include 20 bit lanes, 2 spare lanes and a clock lane.

In an exemplary embodiment, the memory controller 110 includes MCBIST logic to drive MCBIST commands to one or more of the DIMMs 103a-103d. In addition, an exemplary embodiment of the memory controller 110 includes logic to receive data from the MCBIST functional blocks located at one or more of the DIMMs 103a-103d. Further, each of the DIMMs 103a-103d includes a MCBIST functional block to perform the MCBIST functions described herein.

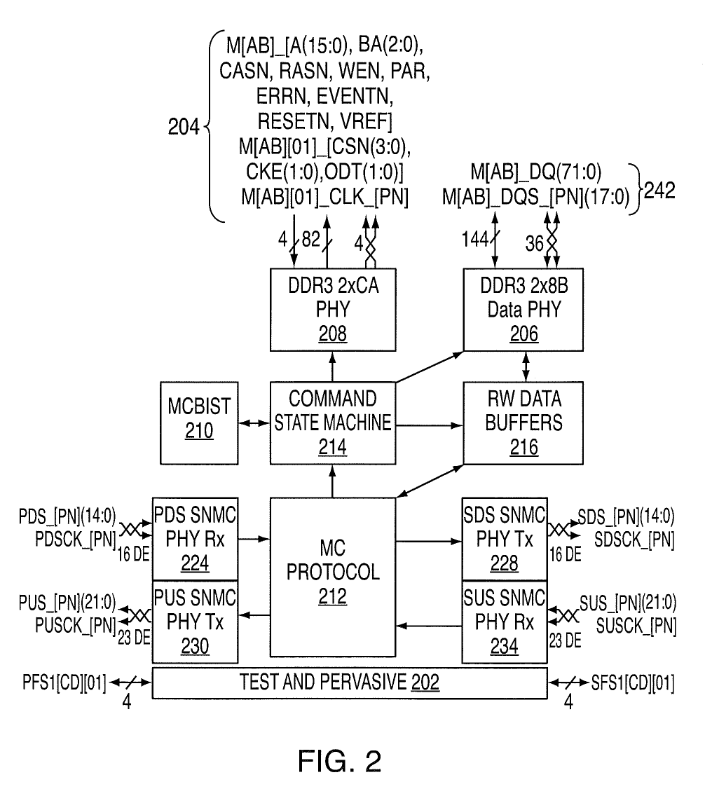

FIG. 2 is a block diagram of the high-level logic flow of a hub device that may be implemented by an exemplary embodiment. The blocks in the lower left and right portions of the drawing (224, 230, 228, 234) are associated with receiving or driving a high-speed bus including the high speed unidirectional upstream and downstream buses previously referenced. “Upstream” refers to the one or more bus(es) passing information to and/or from the hub device in the direction of the memory controller, and “downstream” refers to the bus(es) passing information from the hub device to and/or from the modules and/or buffers located further away from the memory controller.

Referring to FIG. 2, data, command, address, error detection information (e.g. ECC bits and/or CRC bits), and clock signals from an upstream memory module or memory controller are received (in the exemplary embodiment, in the form of data packets), from the high speed cascade interconnect downstream (e.g. the “primary downstream” (PDS)) memory bus into a receiver functional block 224. The receiver functional block 224 includes receiver and re-sync circuitry and other support logic to enable the capturing of information from an upstream device, as well as bitlane sparing circuitry to enable the replacement of one or more defective data and/or clock differential pairs between the receiving device and the sending device (e.g. one or more segments comprising a part of the cascade interconnect channel). In the exemplary embodiment, the sparing circuitry exists in each of the driver and receiver functional blocks (224, 230, 228 and 234), as well as in the memory controller, and permits any one or more of the differential pairs between any two devices on the memory bus to be replaced by an unused and/or underutilized (“spare”) differential signal pair—retaining full function and failure coverage on the affected bus—thereby resulting in improved product long-term memory system reliability and usability given the ability to continue normal operation of the memory system independent of one or more faults resident in one or more segments of the one or more memory system bus(es) which further operate together to comprise the memory controller channel(s).

An exemplary embodiment of the downstream memory bus further enables operation of a sixteen bit, high-speed fully differential, slave receiver bus further including one or more (e.g., differential) spare bitlane(s). In an exemplary embodiment, the receiver functional block 224 transmits the received signals to a memory controller (MC) protocol functional block 212 which both passes the received signals to driver functional block 228 (e.g. secondary downstream (SDS) driver functional block) for re-driving the received and/or re-synchronized signals (e.g. data packet(s)) to a downstream memory buffer and/or buffered memory module, as well as captures the received packet(s) and forwards the data included in the packet(s), in a memory module format and at a memory module data rate to command state machine functional block 214 (e.g. address, command and control information) and read/write data buffers 216 (e.g. data to be written to the memory device(s), generally also including memory date ECC “check” bits). In an exemplary embodiment, MC protocol functional block 212 further includes circuitry to validate the received data prior to and/or after re-driving the received data, e.g. using ECC and/or CRC bits included in the memory packet, enabling the hub to identify and report faults present in the received data since being sent by the transmitting device.

In other exemplary embodiments the hub device circuitry (e.g one or both of blocks 212 and 214) may first determine if the information is intended solely for use by that hub and/or module, negating the need to pass the information to the driver functional block 228 with the accompanying power utilization by that block. The driver functional block 228 provides circuitry (often embodied in the form of logic macros) macros and support logic for the downstream memory bus. As described above, the MC protocol functional block 212 may perform numerous functions, including, but not limited to: segment level sparing to replace one or more defective segments (e.g., differential wires between two memory modules or between a memory module and a memory controller) with one of the spare segments; error detection circuitry; error reporting circuitry; packet capture and data extraction from the packet; and the merging of local data onto the downstream and/or upstream cascade interconnect bus(es), etc.

In an exemplary embodiment, the command state machine functional block 214 determines if the signals (which will generally include one or more of data, command, control and address signals) are directed to and should be processed by the current memory module where the hub device is located. If the signals are directed to the current memory module, then the command state machine functional block 214 determines what actions to take (e.g. by decoding the one or more commands which may be included in the packet) and may initiate memory device actions, write buffer actions, read buffer actions, internal hub actions (e.g. MCBIST) or a combination thereof. In the exemplary embodiment, depending on the type of memory module, the command state machine functional block 214 selects the appropriate drive characteristics, timings and timing relationships based on register settings established during initialization and/or periodic operational evaluation of the memory device interface. In an exemplary embodiment, the MC protocol functional block 212 provides the conversion between signals received via the high speed bus in a packetized memory interface format into a memory module data rate, currently a non-packetized memory module interface format although the memory devices may operate using a device-specific packetized interface in future embodiments, necessitating conversion to that interface.

The read/write data buffers 216 transmit the data (e.g. the information to be written to the memory device(s)) to a memory data interface block 206 and the command state machine functional block 214 transmits the associated addresses, control and command signals to a memory command interface block 208, with the signals consistent with the memory device specification in the exemplary embodiment. The memory command interface functional block 208 transmits the associated addresses, control and command signals 204 to a memory device via an address/command bus (which includes one or more of address, control, command information and error information, as indicated in the exemplary list comprising 204). The memory data interface functional block 206 reads from and writes memory data 242 to a memory device via a data bus, and in the exemplary embodiment, further includes data strobes (e.g. “DQS” signals) to facilitate the identification and capture of data at the receiving device (the buffer and/or the memory device(s)). With ever-higher speed address, control, command and data bus operation, other methods in addition to or instead of strobes will likely be adopted to enable the identification and capture of information at the receiving device(s).

As shown in the exemplary memory device interface located between the memory data interface functional block 206 and the signals listed in 242, two copies of the memory interface information (such as address, control, command, data, error detection bits, etc) required to enable independent operation of a memory port are included on the hub device. In memory data interface functional block 206, 144 data signals are shown, with 72 data signals utilized for each read and/or write port. In addition, 36 DQS (strobe) differential signals are shown, with 18 intended for communication with the 72 data signals (e.g. data bits) comprising each of the two read/write data ports in this embodiment. Similarly, separate copies of such information as address, control and command data are included in the interface(s) connected to the memory command interface block 208. In this exemplary embodiment, two memory ports are supported by the hub device, implemented using additional circuitry (such as drivers and/or receivers) for each of the ports, thereby enabling simultaneous and/or independent operation of the two memory ports and the memory devices attached to these ports. In the exemplary embodiment the simultaneous and/or independent operation of the ports is determined by one or more of the initialization of the hub device and/or one or more of the control and/or command information and the address information received by the hub device. The two ports, as implemented in the exemplary hub circuitry shown in FIG. 2, enable modules and/or other memory subsystems using the hub device to selectively operate as one or two memory subsystems.

Data signals to be transmitted to the memory controller may be temporarily stored in the read/write data buffers 216 after a command, such as a read command, has been executed by the memory module, consistent with the memory device ‘read’ timings. The read/write data buffers 216 selectively transfer the read data into the upstream and/or downstream bus(es) via the MC protocol functional block 212 and upstream and/or downstream bus driver functional block(s) 230 and 228. The driver functional blocks 230 and 228 provide macros and support logic for the upstream (and/or downstream) memory bus(es). While most operations completed in the memory module are expected to be read and/or write operations initiated by the memory controller, in the exemplary embodiment the memory controller built in self-test (MCBIST) functional block 210 may also initiate read and/or write operations to the memory device(s) attached to the present hub device and/or one or more upstream and downstream hub device(s), using the one or more memory ports on the hub device(s). Data read from the memory device(s) may be locally processed within the hub device (e.g. by the MCBIST circuitry) and/or sent upstream and/or downstream to other device(s) on the cascade interconnect bus(es) as shown in the communication paths defined by the arrows in the hub device shown in FIG. 2.

Signals such as data, ECC, CRC, clock error, and other information from the high-speed upstream memory bus are received by the hub device receiver functional block 234. In the exemplary embodiment, these signals are passed upstream to the next memory module or to the memory controller, although other embodiments may first decode the information to determine if the information is intended solely for use by that hub and/or module, negating the need to pass the information upstream with the accompanying power utilization. This determination may be made in relation to any upstream or downstream packet(s), thereby either preventing the re-driving of the received information (e.g. packet(s) and or allowing such re-drive, depending on the information (e.g. command and/or control) information received by the hub. In the exemplary embodiment shown in FIG. 2, such information as data, ECC, CRC, error and clock signals from a downstream memory module are received on the upstream memory bus (e.g. secondary upstream bus (SUS)) into receiver functional block 234. The receiver functional block 234 provides macros and support logic to enable the capture of information received from the upstream memory bus and in exemplary embodiments, also includes segment sparing logic as previously described. The receiver functional block 234 passes the received signals, through the MC protocol functional block 212, to the upstream memory bus via the driver functional block 230. In exemplary embodiments, the received information is also passed to the command state machine and may further pass to the MCBIST and/or R/W data buffers, depending on the contents of the information received on the bus. This operability such modes as the testing of local memory devices by an MCBIST engine in the memory system, without the direct involvement of the memory controller—thus permitting the memory controller to delegate diagnostic, test, characterization and/or other operations to the one or more hub devices on a memory channel.

As described earlier, the MCBIST functional block 210 provides built in self-test functions which act upon one or more of the local buffer, the local memory device(s) attached to the hub device, upstream memory hub device(s), upstream memory device(s), downstream hub device(s) and downstream memory device(s). In response to the built-in self test (BIST) circuitry initiating the test functions, the resulting data, error and/or other information derived from the test is analyzed by the local hub and/or the hub device initiating the test, which may be located upstream or downstream from the memory module and/or interconnections being tested. The test and pervasive functional block 202 communicates with one or more of FSI, I2C, JTAG or alternate bus types to which it is connected, providing an alternate means of communication to the memory controller and/or a service processor (the latter not shown in the figures but otherwise known in the art). The information sent and received by this block is used in exemplary embodiments for such operations as the initialization of the high speed bus(es), initialization of the hub device(s), initialization of the memory device(s) attached to the hub(s), error reporting, error recovery, diagnostic initialization, the reset of attached device(s), the programming of registers, drivers, and/or other circuitry related to the described operations, etc.

The MCBIST functional block 210 provides the capability to read/write different types of data patterns to specified memory locations for the purpose of detecting DIMM and/or DRAM faults. When MCBIST detects a fault, it reports the failing location(s) and data bit position(s), and assists in isolating the failing memory device. In an exemplary embodiment, a test sequence is triggered by a MCBIST maintenance command initiated by firmware or the memory controller.

The block diagram in FIG. 2 is one implementation of a hub device that may be utilized by exemplary embodiments of the present invention. Other implementations and/or functional assignment for these and other functional blocks are possible without departing from the scope of the present invention.

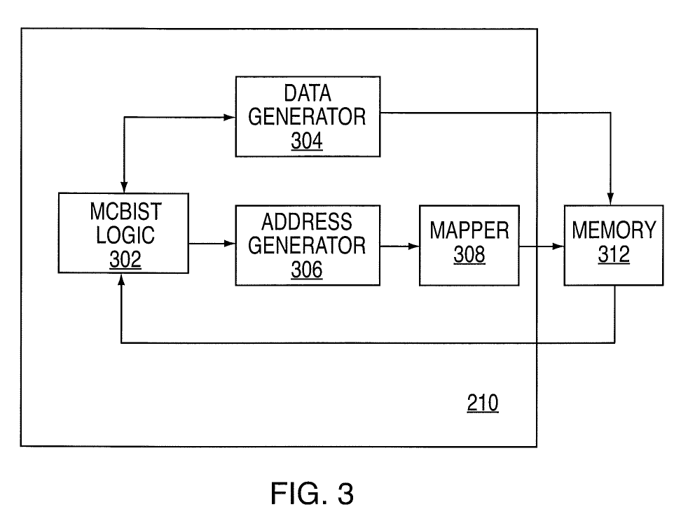

FIG. 3 is a block diagram of a MCBIST functional block 210 that may be implemented by an exemplary embodiment. The elements of the MCBIST functional block 210 may be implemented in hardware or software or a combination of both hardware and software. The MCBIST functional block 210 includes MCBIST logic 302 for receiving a MCBIST command (e.g. from a memory controller or firmware, via the command state machine 214). In addition, the MCBIST logic performs a comparison (e.g., after a test has been performed) between actual data values and expected data values to determine if an error has occurred. In an exemplary embodiment, the MCBIST command specifies an addressing mode. The addressing mode may be sequential or random. In an exemplary embodiment described herein, an additional unique addressing mode, stress test, is also supported. The stress test addressing mode is utilized to stress test selected portions of the memory. When the addressing mode is stress test, the MCBIST command further indicates what portion of the memory is to be stress tested (e.g., a particular column, row, etc.). Other manners of identifying the portion of memory to be stress tested may also be utilized. For example, the command may specify that all rows (or columns) within a bank or rank be stress tested, or that a certain number of randomly selected rows (or columns) be stress tested.

The sample MCBIST functional block 210 depicted in FIG. 3 also includes a data generator 304 for generating data to be utilized during the test, and an address generator 306 for generating the addresses to be utilized during the test. In an exemplary embodiment, the address generator 306 generates sequential or random addresses for specified address ranges. In response to the MCBIST command specifying a stress test addressing mode, sequential addresses are generated by the address generator 306 and then the sequential addresses are modified by a mapper 308 to stress test the portions of memory specified by the command. In an alternate exemplary embodiment, the mapper 308 and the address generator 306 are merged into the same functional block. The mapper 308 outputs addresses to be tested in the memory 312.

In this manner, stress testing is performed without requiring additional hardware in the MCBIST. In a non-stress test, the mapper 308 simply takes the stream of sequential addresses and sends them in such a way to reach the highest possible bandwidth. It typically switches between memory banks, ranks, rows, and then columns in a sequential fashion. This allows the memory access to occur in parallel because when a bank is being accessed, it is unavailable for a period of time while the access is occurring. Because memory sizes vary, the number of banks, ranks, rows, and columns also vary. The mapper 308 block must be flexible such that even though the address generator 306 is providing sequential addresses, the mapping between this set of numbers to banks, ranks, rows and columns do not have any gaps. For example, if one memory DIMM had four banks and another memory DIMM had eight banks, the memory mapper 308 would take addresses ending in 0, 1, 2, 3 to create the bank addresses for the four bank system, and the addresses ending in 0,1,2,3,4,5,6 and 7 for the band address of the eight bank system. In the four bank system, the address 4,5,6, and 7 would be used to access a rank, whereas in the eight bank system, it isn't until the address becomes greater than 8 before the rank selection would be made.

This swapping and mapping is performed typically by using a multiplexing device(s) (mux(es)). In an exemplary embodiment, the addresses coming out of the address generator 306 can go to any address location through the mapper 308. Typically, these muxes are programmed such that banks, ranks, rows and columns are grouped together sequentially. The stress test breaks those rules and programs the muxes in such a way that “sequential” bank bits are interspersed between ranks, rows and columns. The same mixing can happen between ranks, rows and columns.

In an exemplary embodiment, the data to be used in the MCBIST testing (from the data generator 304) and the address to be used in the MCBIST testing (from the mapper 308) are sent to the memory 312 via the command state machine functional block 214 depicted in FIG. 2. In addition, result data (e.g., read data) is returned from the memory 312 to the MCBIST functional block 210 via the command state machine functional block 214.

An example stress test could require that a particular range of rows be stress tested. In this example, the bits in the address are ordered as row/column/bank/rank, with the first group of bits (e.g., 12 bits) specifying a row, the second group of bits (e.g., 12 bits) specifying a column, the third group of bits (e.g,. 2 bits) specifying a bank, and the fourth group of bits (e.g., 2 bits) specifying a rank. The address generator 306 would be utilized in sequential mode to generate address such as:

| ROW | COL | BANK | RANK |
|---|---|---|---|
| Row 0 (0 . . . 0) | Col 0 (0 . . . 0) | Bank 0 (00) | Rank 0 (00) |
| Row 0 (0 . . . 0) | Col 0 (0 . . . 0) | Bank 1 (01) | Rank 0 (00) |
| Row 0 (0 . . . 0) | Col 0 (0 . . . 0) | Bank 2 (10) | Rank 0 (00) |
| Row 0 (0 . . . 0) | Col 0 (0 . . . 0) | Bank 3 (11) | Rank 0 (00) |
| Row 0 (0 . . . 0) | Col 0 (0 . . . 0) | Bank 0 (00) | Rank 1 (01) |
| Row 0 (0 . . . 0) | Col 0 (0 . . . 0) | Bank 1 (01) | Rank 1 (01) |
| Row 0 (0 . . . 0) | Col 0 (0 . . . 0) | Bank 2 (10) | Rank 1 (01) |
| Row 0 (0 . . . 0) | Col 0 (0 . . . 0) | Bank 3 (11) | Rank 1 (01) |
| Row 0 (0 . . . 0) | Col 0 (0 . . . 0) | Bank 0 (00) | Rank 2 (10) |
| Row 0 (0 . . . 0) | Col 0 (0 . . . 0) | Bank 1 (01) | Rank 2 (10) |
| Row 0 (0 . . . 0) | Col 0 (0 . . . 0) | Bank 2 (10) | Rank 2 (10) |
| Row 0 (0 . . . 0) | Col 0 (0 . . . 0) | Bank 3 (11) | Rank 2 (10) |
| Row 0 (0 . . . 0) | Col 0 (0 . . . 0) | Bank 0 (00) | Rank 3 (11) |
| Row 0 (0 . . . 0) | Col 0 (0 . . . 0) | Bank 1 (01) | Rank 3 (11) |
| Row 0 (0 . . . 0) | Col 0 (0 . . . 0) | Bank 2 (10) | Rank 3 (11) |
| Row 0 (0 . . . 0) | Col 0 (0 . . . 0) | Bank 3 (11) | Rank 3 (11) |
| Row 0 (0 . . . 0) | Col 1 (0 . . . 1) | Bank 0 (00) | Rank 0 (00) |
| Row 0 (0 . . . 0) | Col 1 (0 . . . 1) | Bank 1 (01) | Rank 0 (00) |

As shown by the example, in the typical sequential addressing scheme, the bank is switching with each access, so that different banks are accessed by each sequential command. This allows the banks to be refreshed between commands and does not test whether multiple back-to-back commands directed to the same row in the same bank can be processed correctly by the memory.

In an exemplary embodiment, in order to stress test a row within a bank, the mapper 308 swaps some of the address bits to stay within the same bank. One method of doing this is to swap the two least significant bits of the column with the bank bits, resulting in:

| ROW | COL | BANK | RANK |
|---|---|---|---|
| Row 0 (0 . . . 0) | Col 0 (0 . . . 00) | Bank 0 (00) | Rank 0 (00) |
| Row 0 (0 . . . 0) | Col 1 (0 . . . 01) | Bank 0 (00) | Rank 0 (00) |
| Row 0 (0 . . . 0) | Col 2 (0 . . . 10) | Bank 0 (00) | Rank 0 (00) |
| Row 0 (0 . . . 0) | Col 3 (0 . . . 11) | Bank 0 (00) | Rank 0 (00) |
| Row 0 (0 . . . 0) | Col 0 (0 . . . 00) | Bank 0 (00) | Rank 1 (01) |
| Row 0 (0 . . . 0) | Col 1 (0 . . . 01) | Bank 0 (00) | Rank 1 (01) |
| Row 0 (0 . . . 0) | Col 2 (0 . . . 10) | Bank 0 (00) | Rank 1 (01) |
| Row 0 (0 . . . 0) | Col 3 (0 . . . 11) | Bank 0 (00) | Rank 1 (01) |
| Row 0 (0 . . . 0) | Col 0 (0 . . . 00) | Bank 0 (00) | Rank 2 (10) |
| Row 0 (0 . . . 0) | Col 1 (0 . . . 01) | Bank 0 (00) | Rank 2 (10) |
| Row 0 (0 . . . 0) | Col 2 (0 . . . 10) | Bank 0 (00) | Rank 2 (10) |
| Row 0 (0 . . . 0) | Col 3 (0 . . . 11) | Bank 0 (00) | Rank 2 (10) |
| Row 0 (0 . . . 0) | Col 0 (0 . . . 00) | Bank 0 (00) | Rank 3 (11) |
| Row 0 (0 . . . 0) | Col 1 (0 . . . 01) | Bank 0 (00) | Rank 3 (11) |
| Row 0 (0 . . . 0) | Col 2 (0 . . . 10) | Bank 0 (00) | Rank 3 (11) |
| Row 0 (0 . . . 0) | Col 3 (0 . . . 11) | Bank 0 (00) | Rank 3 (11) |
| Row 0 (0 . . . 0) | Col 0 (0 . . . 00) | Bank 1 (01) | Rank 0 (00) |
| Row 0 (0 . . . 0) | Col 1 (0 . . . 01) | Bank 1 (01) | Rank 0 (00) |

The above sequence, sequentially tests columns 0-3 in bank 0, rank 0. This test could be expanded to test columns 4-7 by inserting a “1” in bit three of column address. Alternatively, the complement of the most significant bit of the row address could be inserted into bit three of the column address. This would result in:

| ROW | COL | BANK | RANK |
|---|---|---|---|
| Row 0 (0 . . . 0) | Col 4 (0 . . . 100) | Bank 0 (00) | Rank 0 (00) |
| Row 0 (0 . . . 0) | Col 5 (0 . . . 101) | Bank 0 (00) | Rank 0 (00) |
| Row 0 (0 . . . 0) | Col 6 (0 . . . 110) | Bank 0 (00) | Rank 0 (00) |
| Row 0 (0 . . . 0) | Col 7 (0 . . . 111) | Bank 0 (00) | Rank 0 (00) |
| Row 0 (0 . . . 0) | Col 4 (0 . . . 100) | Bank 0 (00) | Rank 1 (01) |
| Row 0 (0 . . . 0) | Col 5 (0 . . . 101) | Bank 0 (00) | Rank 1 (01) |
| Row 0 (0 . . . 0) | Col 6 (0 . . . 110) | Bank 0 (00) | Rank 1 (01) |
| Row 0 (0 . . . 0) | Col 7 (0 . . . 111) | Bank 0 (00) | Rank 1 (01) |
| Row 0 (0 . . . 0) | Col 4 (0 . . . 100) | Bank 0 (00) | Rank 2 (10) |
| Row 0 (0 . . . 0) | Col 5 (0 . . . 101) | Bank 0 (00) | Rank 2 (10) |
| Row 0 (0 . . . 0) | Col 6 (0 . . . 110) | Bank 0 (00) | Rank 2 (10) |
| Row 0 (0 . . . 0) | Col 7 (0 . . . 111) | Bank 0 (00) | Rank 2 (10) |
| Row 0 (0 . . . 0) | Col 4 (0 . . . 100) | Bank 0 (00) | Rank 3 (11) |
| Row 0 (0 . . . 0) | Col 5 (0 . . . 101) | Bank 0 (00) | Rank 3 (11) |
| Row 0 (0 . . . 0) | Col 6 (0 . . . 110) | Bank 0 (00) | Rank 3 (11) |
| Row 0 (0 . . . 0) | Col 7 (0 . . . 111) | Bank 0 (00) | Rank 3 (11) |
| Row 0 (0 . . . 0) | Col 4 (0 . . . 100) | Bank 1 (01) | Rank 0 (00) |
| Row 0 (0 . . . 0) | Col 5 (0 . . . 101) | Bank 1 (01) | Rank 0 (00) |

Any number of bit swappings and bit substitutions may be made based on the area of the memory to be tested. The above is just one example of one way to stress test columns 0-7, ranks 0-3 of bank 0. The above tests may be performed for all columns in bank 0, rank 0 first, and then performed for all columns in bank 0, rank 1 and not broken into two separate tests as shown above, In addition, the columns within a row, within a bank and rank may be accessed in a more random manner and not sequentially as shown above. This setup is typically done during system initialization, but can also be reconfigured between starting the MCBIST engine. Because the setting of the muxes within the mapper 308 is configurable within normal register access, many different stress tests can be created with a software reload of the mux settings.

Additional stress tests may be exercised to stay on the same column within a bank in order to exercise the rows. One way to perform this would be to swap bits in the row and bank addresses. Another stress test could be set up to switch between ranks within the same bank. An exemplary embodiment provides the ability to reorder addresses in the mapper 308, and thus, any portion(s) of the memory 312 may be targeted by a stress test.

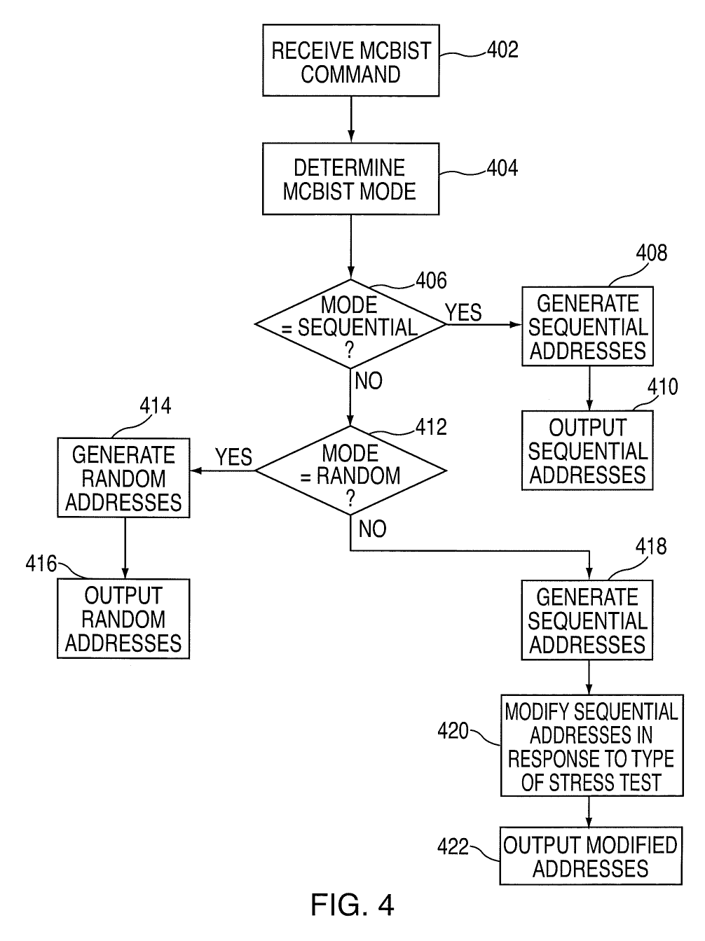

FIG. 4 is a process flow that may by implemented to provide programmable MCBIST capability in an exemplary embodiment. In an exemplary embodiment, the processing depicted in FIG. 4 is performed by the MCBIST functional block 210. At block 402, a MCBIST command is received. In an exemplary embodiment, the MCBIST command specifies a memory addressing mode, and optionally, a target memory location to be tested. At block 404, the MCBIST functional block 210 determines if the MCBIST addressing mode is sequential, random, or stress test. If the addressing mode is sequential, as determined at block 406, then block 408 is performed to generate sequential addresses, followed by block 410 where the sequential addresses are output to a memory (e.g., via a transmitter) to be utilized by a MCBIST test. If the addressing mode is random, as determined at block 412, then block 414 is performed to generate random addresses, followed by block 416 where the random addresses are output to the memory to be utilized by the MCBIST test.

If the addressing mode is sequential then block 418 is performed to generate sequential addresses. Next, block 420 is performed to modify the sequential address in response to the type of stress test and/or the memory location to be tested. At block 420, the modified addresses are output to the memory to be utilized by the MCBIST test.

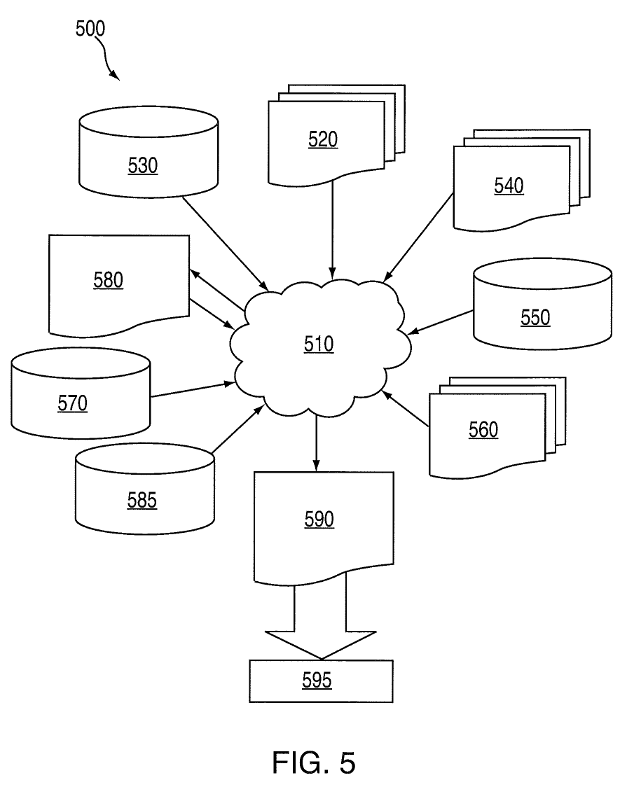

FIG. 5 illustrates multiple such design structures including an input design structure 520 that is preferably processed by a design process 510. Design structure 520 may be a logical simulation design structure generated and processed by design process 510 to produce a logically equivalent functional representation of a hardware device. Design structure 520 may also or alternatively comprise data and/or program instructions that when processed by design process 510, generate a functional representation of the physical structure of a hardware device. Whether representing functional and/or structural design features, design structure 520 may be generated using electronic computer-aided design (ECAD) such as implemented by a core developer/designer. When encoded on a machine-readable data transmission, gate array, or storage medium, design structure 520 may be accessed and processed by one or more hardware and/or software modules within design process 510 to simulate or otherwise functionally represent an electronic component, circuit, electronic or logic module, apparatus, device, or system such as those shown in FIGS. 1-4. As such, design structure 520 may comprise files or other data structures including human and/or machine-readable source code, compiled structures, and computer-executable code structures that when processed by a design or simulation data processing system, functionally simulate or otherwise represent circuits or other levels of hardware logic design. Such data structures may include hardware-description language (HDL) design entities or other data structures conforming to and/or compatible with lower-level HDL design languages such as Verilog and VHDL, and/or higher level design languages such as C or C++.

Design process 510 preferably employs and incorporates hardware and/or software modules for synthesizing, translating, or otherwise processing a design/simulation functional equivalent of the components, circuits, devices, or logic structures shown in FIGS. 1-4 to generate a netlist 580 which may contain design structures such as design structure 520. Netlist 580 may comprise, for example, compiled or otherwise processed data structures representing a list of wires, discrete components, logic gates, control circuits, I/O devices, models, etc. that describes the connections to other elements and circuits in an integrated circuit design. Netlist 580 may be synthesized using an iterative process in which netlist 580 is resynthesized one or more times depending on design specifications and parameters for the device. As with other design structure types described herein, netlist 580 may be recorded on a machine-readable data storage medium or programmed into a programmable gate array. The medium may be a non-volatile storage medium such as a magnetic or optical disk drive, a programmable gate array, a compact flash, or other flash memory. Additionally, or in the alternative, the medium may be a system or cache memory, buffer space, or electrically or optically conductive devices and materials on which data packets may be transmitted and intermediately stored via the Internet, or other networking suitable means.

Design process 510 may include hardware and software modules for processing a variety of input data structure types including netlist 580. Such data structure types may reside, for example, within library elements 530 and include a set of commonly used elements, circuits, and devices, including models, layouts, and symbolic representations, for a given manufacturing technology (e.g., different technology nodes, 32 nm, 45 nm, 90 nm, etc.). The data structure types may further include design specifications 540, characterization data 550, verification data 560, design rules 570, and test data files 585 which may include input test patterns, output test results, and other testing information. Design process 510 may further include, for example, standard mechanical design processes such as stress analysis, thermal analysis, mechanical event simulation, process simulation for operations such as casting, molding, and die press forming, etc. One of ordinary skill in the art of mechanical design can appreciate the extent of possible mechanical design tools and applications used in design process 510 without deviating from the scope and spirit of the invention. Design process 510 may also include modules for performing standard circuit design processes such as timing analysis, verification, design rule checking, place and route operations, etc.

Design process 510 employs and incorporates logic and physical design tools such as HDL compilers and simulation model build tools to process design structure 520 together with some or all of the depicted supporting data structures along with any additional mechanical design or data (if applicable), to generate a second design structure 590. Design structure 590 resides on a storage medium or programmable gate array in a data format used for the exchange of data of mechanical devices and structures (e.g. information stored in a IGES, DXF, Parasolid XT, JT, DRG, or any other suitable format for storing or rendering such mechanical design structures). Similar to design structure 520, design structure 590 preferably comprises one or more files, data structures, or other computer-encoded data or instructions that reside on transmission or data storage media and that when processed by an ECAD system generate a logically or otherwise functionally equivalent form of one or more of the embodiments of the invention shown in FIGS. 1-4. In one embodiment, design structure 590 may comprise a compiled, executable HDL simulation model that functionally simulates the devices shown in FIGS. 1-4.

Design structure 590 may also employ a data format used for the exchange of layout data of integrated circuits and/or symbolic data format (e.g. information stored in a GDSII (GDS2), GL1, OASIS, map files, or any other suitable format for storing such design data structures). Design structure 590 may comprise information such as, for example, symbolic data, map files, test data files, design content files, manufacturing data, layout parameters, wires, levels of metal, vias, shapes, data for routing through the manufacturing line, and any other data required by a manufacturer or other designer/developer to produce a device or structure as described above and shown in FIGS. 1-4. Design structure 590 may then proceed to a stage 595 where, for example, design structure 590: proceeds to tape-out, is released to manufacturing, is released to a mask house, is sent to another design house, is sent back to the customer, etc.

In an exemplary embodiment, hub devices may be connected to the memory controller through a multi-drop or point-to-point bus structure (which may further include a cascade connection to one or more additional hub devices). Memory access requests are transmitted by the memory controller through the bus structure (e.g., the memory bus) to the selected hub(s). In response to receiving the memory access requests, the hub device translates the memory access requests to control the memory devices to store write data from the hub device or to provide read data to the hub device. Read data is encoded into one or more communication packet(s) and transmitted through the memory bus(es) to the memory controller.

In alternate exemplary embodiments, the memory controller(s) may be integrated together with one or more processor chips and supporting logic, packaged in a discrete chip (commonly called a “northbridge” chip), included in a multi-chip carrier with the one or more processors and/or supporting logic, or packaged in various alternative forms that best match the application/environment. Any of these solutions may or may not employ one or more narrow/high speed links to connect to one or more hub chips and/or memory devices.

The memory modules may be implemented by a variety of technology including a DIMM, a single in-line memory module (SIMM) and/or other memory module or card structures. In general, a DIMM refers to a small circuit board which is comprised primarily of random access memory (RAM) integrated circuits or die on one or both sides with signal and/or power pins on both sides of the board. This can be contrasted to a SIMM which is a small circuit board or substrate composed primarily of RAM integrated circuits or die on one or both sides and single row of pins along one long edge. DIMMs have been constructed with pincounts ranging from 100 pins to over 300 pins. In exemplary embodiments described herein, memory modules may include two or more hub devices.

In exemplary embodiments, the memory bus is constructed using multi-drop connections to hub devices on the memory modules and/or using point-to-point connections. The downstream portion of the controller interface (or memory bus), referred to as the downstream bus, may include command, address, data and other operational, initialization or status information being sent to the hub devices on the memory modules. Each hub device may simply forward the information to the subsequent hub device(s) via bypass circuitry; receive, interpret and re-drive the information if it is determined to be targeting a downstream hub device; re-drive some or all of the information without first interpreting the information to determine the intended recipient; or perform a subset or combination of these options.

The upstream portion of the memory bus, referred to as the upstream bus, returns requested read data and/or error, status or other operational information, and this information may be forwarded to the subsequent hub devices via bypass circuitry; be received, interpreted and re-driven if it is determined to be targeting an upstream hub device and/or memory controller in the processor complex; be re-driven in part or in total without first interpreting the information to determine the intended recipient; or perform a subset or combination of these options.

In alternate exemplary embodiments, the point-to-point bus includes a switch or bypass mechanism which results in the bus information being directed to one of two or more possible hub devices during downstream communication (communication passing from the memory controller to a hub device on a memory module), as well as directing upstream information (communication from a hub device on a memory module to the memory controller), often by way of one or more upstream hub devices. Further embodiments include the use of continuity modules, such as those recognized in the art, which, for example, can be placed between the memory controller and a first populated hub device (i.e., a hub device that is in communication with one or more memory devices), in a cascade interconnect memory system, such that any intermediate hub device positions between the memory controller and the first populated hub device include a means by which information passing between the memory controller and the first populated hub device can be received even if the one or more intermediate hub device position(s) do not include a hub device. The continuity module(s) may be installed in any module position(s), subject to any bus restrictions, including the first position (closest to the main memory controller, the last position (prior to any included termination) or any intermediate position(s). The use of continuity modules may be especially beneficial in a multi-module cascade interconnect bus structure, where an intermediate hub device on a memory module is removed and replaced by a continuity module, such that the system continues to operate after the removal of the intermediate hub device. In more common embodiments, the continuity module(s) would include either interconnect wires to transfer all required signals from the input(s) to the corresponding output(s), or be re-driven through a repeater device. The continuity module(s) might further include a non-volatile storage device (such as an EEPROM), but would not include main memory storage devices.

In exemplary embodiments, the memory system includes one or more hub devices on one or more memory modules connected to the memory controller via a cascade interconnect memory bus, however other memory structures may be implemented such as a point-to-point bus, a multi-drop memory bus or a shared bus. Depending on the signaling methods used, the target operating frequencies, space, power, cost, and other constraints, various alternate bus structures may be considered. A point-to-point bus may provide the optimal performance in systems produced with electrical interconnections, due to the reduced signal degradation that may occur as compared to bus structures having branched signal lines, switch devices, or stubs. However, when used in systems requiring communication with multiple devices or subsystems, this method will often result in significant added component cost and increased system power, and may reduce the potential memory density due to the need for intermediate buffering and/or re-drive.

Although not shown in the Figures, the memory modules or hub devices may also include a separate bus, such as a ‘presence detect’ bus, an I2C bus and/or an SMBus which is used for one or more purposes including the determination of the hub device an/or memory module attributes (generally after power-up), the reporting of fault or status information to the system, the configuration of the hub device(s) and/or memory subsystem(s) after power-up or during normal operation or other purposes. Depending on the bus characteristics, this bus might also provide a means by which the valid completion of operations could be reported by the hub devices and/or memory module(s) to the memory controller(s), or the identification of failures occurring during the execution of the main memory controller requests.

Performances similar to those obtained from point-to-point bus structures can be obtained by adding switch devices. These and other solutions offer increased memory packaging density at lower power, while retaining many of the characteristics of a point-to-point bus. Multi-drop busses provide an alternate solution, albeit often limited to a lower operating frequency, but at a cost/performance point that may be advantageous for many applications. Optical bus solutions permit significantly increased frequency and bandwidth potential, either in point-to-point or multi-drop applications, but may incur cost and space impacts.

As used herein the term “buffer” or “buffer device” refers to a temporary storage unit (as in a computer), especially one that accepts information at one rate and delivers it another. In exemplary embodiments, a buffer is an electronic device that provides compatibility between two signals (e.g., changing voltage levels or current capability). The term “hub” is sometimes used interchangeably with the term “buffer.” A hub is a device containing multiple ports that is connected to several other devices. A port is a portion of an interface that serves a congruent I/O functionality (e.g., a port may be utilized for sending and receiving data, address, and control information over one of the point-to-point links, or busses). A hub may be a central device that connects several systems, subsystems, or networks together. A passive hub may simply forward messages, while an active hub, or repeater, amplifies and refreshes the stream of data which otherwise would deteriorate over a distance. The term hub device, as used herein, refers to a hub chip that includes logic (hardware and/or software) for performing memory functions.

Also as used herein, the term “bus” refers to one of the sets of conductors (e.g., wires, and printed circuit board traces or connections in an integrated circuit) connecting two or more functional units in a computer. The data bus, address bus and control signals, despite their names, constitute a single bus since each are often useless without the others. A bus may include a plurality of signal lines, each signal line having two or more connection points, that form a main transmission path that electrically connects two or more transceivers, transmitters and/or receivers. The term “bus” is contrasted with the term “channel” which is often used to describe the function of a “port” as related to a memory controller in a memory system, and which may include one or more busses or sets of busses. The term “channel” as used herein refers to a port on a memory controller. Note that this term is often used in conjunction with I/O or other peripheral equipment, however the term channel has been adopted by some to describe the interface between a processor or memory controller and one of one or more memory subsystem(s).

Further, as used herein, the term “daisy chain” refers to a bus wiring structure in which, for example, device A is wired to device B, device B is wired to device C, etc. The last device is typically wired to a resistor or terminator. All devices may receive identical signals or, in contrast to a simple bus, each device may modify one or more signals before passing them on. A “cascade” or “cascade interconnect” as used herein refers to a succession of stages or units or a collection of interconnected networking devices, typically hubs, in which the hubs operate as a logical repeater, further permitting merging data to be concentrated into the existing data stream. Also as used herein, the term “point-to-point” bus and/or link refer to one or a plurality of signal lines that may each include one or more terminators. In a point-to-point bus and/or link, each signal line has two transceiver connection points, with each transceiver connection point coupled to transmitter circuitry, receiver circuitry or transceiver circuitry. A signal line refers to one or more electrical conductors or optical carriers, generally configured as a single carrier or as two or more carriers, in a twisted, parallel, or concentric arrangement, used to transport at least one logical signal.

Memory devices are generally defined as integrated circuits that are composed primarily of memory (storage) cells, such as DRAMs (Dynamic Random Access Memories), SRAMs (Static Random Access Memories), FeRAMs (Ferro-Electric RAMs), MRAMs (Magnetic Random Access Memories), Flash Memory and other forms of random access and related memories that store information in the form of electrical, optical, magnetic, biological or other means. Dynamic memory device types may include asynchronous memory devices such as FPM DRAMs (Fast Page Mode Dynamic Random Access Memories), EDO (Extended Data Out) DRAMs, BEDO (Burst EDO) DRAMs, SDR (Single Data Rate) Synchronous DRAMs, DDR (Double Data Rate) Synchronous DRAMs or any of the expected follow-on devices such as DDR2, DDR3, DDR4 and related technologies such as Graphics RAMs, Video RAMs, LP RAM (Low Power DRAMs) which are often based on the fundamental functions, features and/or interfaces found on related DRAMs.

Memory devices may be utilized in the form of chips (die) and/or single or multi-chip packages of various types and configurations. In multi-chip packages, the memory devices may be packaged with other device types such as other memory devices, logic chips, analog devices and programmable devices, and may also include passive devices such as resistors, capacitors and inductors. These packages may include an integrated heat sink or other cooling enhancements, which may be further attached to the immediate carrier or another nearby carrier or heat removal system.

Module support devices (such as buffers, hubs, hub logic chips, registers, PLL's, DLL's, non-volatile memory, etc) may be comprised of multiple separate chips and/or components, may be combined as multiple separate chips onto one or more substrates, may be combined onto a single package or even integrated onto a single device—based on technology, power, space, cost and other tradeoffs. In addition, one or more of the various passive devices such as resistors, capacitors may be integrated into the support chip packages, or into the substrate, board or raw card itself, based on technology, power, space, cost and other tradeoffs. These packages may include an integrated heat sink or other cooling enhancements, which may be further attached to the immediate carrier or another nearby carrier or heat removal system.

Memory devices, hubs, buffers, registers, clock devices, passives and other memory support devices and/or components may be attached to the memory subsystem and/or hub device via various methods including soldered interconnects, conductive adhesives, socket structures, pressure contacts and other methods which enable communication between the two or more devices via electrical, optical or alternate means.

The one or more memory modules (or memory subsystems) and/or hub devices may be electrically connected to the memory system, processor complex, computer system or other system environment via one or more methods such as soldered interconnects, connectors, pressure contacts, conductive adhesives, optical interconnects and other communication and power delivery methods. Connector systems may include mating connectors (male/female), conductive contacts and/or pins on one carrier mating with a male or female connector, optical connections, pressure contacts (often in conjunction with a retaining mechanism) and/or one or more of various other communication and power delivery methods. The interconnection(s) may be disposed along one or more edges of the memory assembly and/or placed a distance from an edge of the memory subsystem depending on such application requirements as ease-of-upgrade/repair, available space/volume, heat transfer, component size and shape and other related physical, electrical, optical, visual/physical access, etc. Electrical interconnections on a memory module are often referred to as contacts, or pins, or tabs. Electrical interconnections on a connector are often referred to as contacts or pins.

As used herein, the term memory subsystem refers to, but is not limited to: one or more memory devices; one or more memory devices and associated interface and/or timing/control circuitry; and/or one or more memory devices in conjunction with a memory buffer, hub device, and/or switch. The term memory subsystem may also refer to one or more memory devices, in addition to any associated interface and/or timing/control circuitry and/or a memory buffer, hub device or switch, assembled into a substrate, a card, a module or related assembly, which may also include a connector or similar means of electrically attaching the memory subsystem with other circuitry. The memory modules described herein may also be referred to as memory subsystems because they include one or more memory devices and hub devices.

Additional functions that may reside local to the memory subsystem and/or hub device include write and/or read buffers, one or more levels of memory cache, local pre-fetch logic, data encryption/decryption, compression/decompression, protocol translation, command prioritization logic, voltage and/or level translation, error detection and/or correction circuitry, data scrubbing, local power management circuitry and/or reporting, operational and/or status registers, initialization circuitry, performance monitoring and/or control, one or more co-processors, search engine(s) and other functions that may have previously resided in other memory subsystems. By placing a function local to the memory subsystem, added performance may be obtained as related to the specific function, often while making use of unused circuits within the subsystem.

Memory subsystem support device(s) may be directly attached to the same substrate or assembly onto which the memory device(s) are attached, or may be mounted to a separate interposer or substrate also produced using one or more of various plastic, silicon, ceramic or other materials which include electrical, optical or other communication paths to functionally interconnect the support device(s) to the memory device(s) and/or to other elements of the memory or computer system.

Information transfers (e.g. packets) along a bus, channel, link or other naming convention applied to an interconnection method may be completed using one or more of many signaling options. These signaling options may include such methods as single-ended, differential, optical or other approaches, with electrical signaling further including such methods as voltage or current signaling using either single or multi-level approaches. Signals may also be modulated using such methods as time or frequency, non-return to zero, phase shift keying, amplitude modulation and others, Voltage levels are expected to continue to decrease, with 1.5V, 1.2V, 1V and lower signal voltages expected consistent with (but often independent of) the reduced power supply voltages required for the operation of the associated integrated circuits themselves.

One or more clocking methods may be utilized within the memory subsystem and the memory system itself, including global clocking, source-synchronous clocking, encoded clocking or combinations of these and other methods. The clock signaling may be identical to that of the signal lines themselves, or may utilize one of the listed or alternate methods that is more conducive to the planned clock frequency(ies), and the number of clocks planned within the various subsystems. A single clock may be associated with all communication to and from the memory, as well as all clocked functions within the memory subsystem, or multiple clocks may be sourced using one or more methods such as those described earlier. When multiple clocks are used, the functions within the memory subsystem may be associated with a clock that is uniquely sourced to the subsystem, or may be based on a clock that is derived from the clock related to the information being transferred to and from the memory subsystem (such as that associated with an encoded clock). Alternately, a unique clock may be used for the information transferred to the memory subsystem, and a separate clock for information sourced from one (or more) of the memory subsystems. The clocks themselves may operate at the same or frequency multiple of the communication or functional frequency, and may be edge-aligned, center-aligned or placed in an alternate timing position relative to the data, command or address information.

Information passing to the memory subsystem(s) will generally be composed of address, command and data, as well as other signals generally associated with requesting or reporting status or error conditions, resetting the memory, completing memory or logic initialization and other functional, configuration or related information. Information passing from the memory subsystem(s) may include any or all of the information passing to the memory subsystem(s), however generally will not include address and command information. This information may be communicated using communication methods that may be consistent with normal memory device interface specifications (generally parallel in nature), the information may be encoded into a ‘packet’ structure, which may be consistent with future memory interfaces or simply developed to increase communication bandwidth and/or enable the subsystem to operate independently of the memory technology by converting the received information into the format required by the receiving device(s).

Initialization of the memory subsystem may be completed via one or more methods, based on the available interface busses, the desired initialization speed, available space, cost/complexity objectives, subsystem interconnect structures, the use of alternate processors (such as a service processor) which may be used for this and other purposes, etc. In one embodiment, the high speed bus may be used to complete the initialization of the memory subsystem(s), generally by first completing a training process to establish reliable communication, then by interrogation of the attribute or ‘presence detect’ data associated with the various components and/or characteristics associated with that subsystem, and ultimately by programming the appropriate devices with information associated with the intended operation within that system. In a cascaded system, communication with the first memory subsystem would generally be established, followed by subsequent (downstream) subsystems in the sequence consistent with their position along the cascade interconnect bus.

A second initialization method would include one in which the high speed bus is operated at one frequency during the initialization process, then at a second (and generally higher) frequency during the normal operation. In this embodiment, it may be possible to initiate communication with all of the memory subsystems on the cascade interconnect bus prior to completing the interrogation and/or programming of each subsystem, due to the increased timing margins associated with the lower frequency operation.

A third initialization method might include operation of the cascade interconnect bus at the normal operational frequency(ies), while increasing the number of cycles associated with each address, command and/or data transfer. In one embodiment, a packet containing all or a portion of the address, command and/or data information might be transferred in one clock cycle during normal operation, but the same amount and/or type of information might be transferred over two, three or more cycles during initialization. This initialization process would therefore be using a form of ‘slow’ commands, rather than ‘normal’ commands, and this mode might be automatically entered at some point after power-up and/or re-start by each of the subsystems and the memory controller by way of POR (power-on-reset) logic included in each of these subsystems.

A fourth initialization method might utilize a distinct bus, such as a presence detect bus (such as the one defined in U.S. Pat. No. 5,513,135 to Dell et al., of common assignment herewith), an I2C bus (such as defined in published JEDEC standards such as the 168 Pin DIMM family in publication 21-C revision 7R8) and/or the SMBUS, which has been widely utilized and documented in computer systems using such memory modules. This bus might be connected to one or more modules within a memory system in a daisy chain/cascade interconnect, multi-drop or alternate structure, providing an independent means of interrogating memory subsystems, programming each of the one or more memory subsystems to operate within the overall system environment, and adjusting the operational characteristics at other times during the normal system operation based on performance, thermal, configuration or other changes desired or detected in the system environment.

Other methods for initialization can also be used, in conjunction with or independent of those listed. The use of a separate bus, such as described in the fourth embodiment above, also offers the advantage of providing an independent means for both initialization and uses other than initialization, such as described in U.S. Pat. No. 6,381,685 to Dell et al., of common assignment herewith, including changes to the subsystem operational characteristics on-the-fly and for the reporting of and response to operational subsystem information such as utilization, temperature data, failure information or other purposes.

With improvements in lithography, better process controls, the use of materials with lower resistance, increased field sizes and other semiconductor processing improvements, increased device circuit density (often in conjunction with increased die sizes) will help facilitate increased function on integrated devices as well as the integration of functions previously implemented on separate devices. This integration will serve to improve overall performance of the intended function, as well as promote increased storage density, reduced power, reduced space requirements, lower cost and other manufacturer and customer benefits. This integration is a natural evolutionary process, and may result in the need for structural changes to the fundamental building blocks associated with systems.

The integrity of the communication path, the data storage contents and all functional operations associated with each element of a memory system or subsystem can be assured, to a high degree, with the use of one or more fault detection and/or correction methods. Any or all of the various elements may include error detection and/or correction methods such as CRC (Cyclic Redundancy Code), EDC (Error Detection and Correction), parity or other encoding/decoding methods suited for this purpose. Further reliability enhancements may include operation re-try (to overcome intermittent faults such as those associated with the transfer of information), the use of one or more alternate or replacement communication paths to replace failing paths and/or lines, complement-re-complement techniques or alternate methods used in computer, communication and related systems.

The use of bus termination, on busses as simple as point-to-point links or as complex as multi-drop structures, is becoming more common consistent with increased performance demands. A wide variety of termination methods can be identified and/or considered, and include the use of such devices as resistors, capacitors, inductors or any combination thereof, with these devices connected between the signal line and a power supply voltage or ground, a termination voltage or another signal. The termination device(s) may be part of a passive or active termination structure, and may reside in one or more positions along one or more of the signal lines, and/or as part of the transmitter and/or receiving device(s). The terminator may be selected to match the impedance of the transmission line, or selected via an alternate approach to maximize the useable frequency, operating margins and related attributes within the cost, space, power and other constraints.

Technical effects and benefits include the ability to utilize existing MCBIST circuitry to perform stress testing.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. In addition, it will be understood that the use of the terms first, second, etc. do not denote any order or importance, but rather the terms first, second, etc. are used to distinguish one element from another.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer-usable or computer-readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for generating addresses in a memory card built in self-test (MCBIST) for testing memory devices, the method comprising:
receiving a MCBIST command;
determining an addressing mode of the MCBIST command;
generating sequential addresses and modifying the sequential addresses in response to the addressing mode being a stress test mode, the modifying including swapping bits in a sequential address with other bits in the sequential address to target selected portions of a memory; and
outputting the modified sequential addresses to the memory, the modified sequential addresses to be utilized in a MCBIST stress test of the memory.

2. The method of claim 1 wherein the MCBIST command specifies the selected portions of the memory.

3. The method of claim 1 wherein the selected portions of the memory include a row within a bank and rank, of the memory.

4. The method of claim 1 wherein the selected portions of the memory include a column within a bank and rank of the memory.

5. The method of claim 1 wherein the selected portions of the memory include a bank and rank within the memory.

6. The method of claim 1 wherein the selected portions of the memory include a bank of the memory.

7. The method of claim 1 further comprising generating the sequential addresses and outputting the sequential addresses to be utilized in a MCBIST test of the memory in response to the addressing mode being a sequential mode.

8. The method of claim 1 further comprising generating random addresses and outputting the random addresses to be utilized in a MCBIST test of the memory in response to the addressing mode being a random mode.

9. A system for generating addresses in a MCBIST for testing memory devices, the system comprising:
MCBIST logic for receiving a MCBIST command and for determining an addressing mode of the MCBIST command;
an address generator for generating sequential addresses in response to the addressing mode being a stress test mode;
a mapper for modifying the sequential addresses in response to the addressing mode being a stress test mode, the modifying including swapping bits in a sequential address with other bits in the sequential address to target selected portions of a memory; and
a transmitter for outputting the modified sequential addresses to the memory, the modified sequential addresses to be utilized in a MCBIST stress test of the memory.

10. The system of claim 9 wherein the MCBIST command specifies the selected portions of the memory.

11. The system of claim 9 wherein the selected portions of the memory include a row within a bank and rank of the memory.

12. The system of claim 9 wherein the selected portions of the memory include a column within a bank and rank of the memory.

13. The system of claim 9 wherein the address generator generates the sequential addresses and the transmitter outputs the sequential addresses to the memory to be utilized in a MCBIST test of the memory in response to the addressing mode being a sequential mode.

14. The system of claim 9 wherein the address generator generates random addresses and the transmitter outputs the random addresses to the memory to be utilized in a MCBIST test of the memory in response to the addressing mode being a random mode.

15. A hub device comprising:
an interface to a high speed bus for communicating with a memory controller, the memory controller and the hub device included in a cascade interconnect memory system, the hub device receiving MCBIST commands from the memory controller;
MCBIST logic for receiving the MCBIST command and for determining an addressing mode of the MCBIST command;
an address generator for generating sequential addresses in response to the addressing mode being a stress test mode;
a mapper for modifying the sequential addresses in response to the addressing mode being a stress test mode, the modifying including swapping bits in a sequential address with other bits in the sequential address to target selected portions of a memory; and
a transmitter for outputting the modified sequential addresses to the memory, the modified sequential addresses to be utilized in a MCBIST stress test of the memory.

16. The hub device of claim 15 wherein the MCBIST command specifies the selected portions of the memory.

17. The hub device of claim 15 wherein the selected portions of the memory include a row within a bank and rank of the memory or a column within a bank and rank of the memory.

18. The hub device of claim 15 wherein the address generator generates the sequential addresses and the transmitter outputs the sequential addresses to the memory to be utilized in a MCBIST test of the memory in response to the addressing mode being a sequential mode.

19. The hub device of claim 15 wherein the address generator generates random addresses and the transmitter outputs the random addresses to the memory to be utilized in a MCBIST test of the memory in response to the addressing mode being a random mode.

20. A design structure tangibly embodied in a machine readable medium for designing, manufacturing, or testing an integrated circuit, the design structure comprising;
MCBIST logic for receiving a MCBIST command and for determining an addressing mode of the MCBIST command;
an address generator for generating sequential addresses in response to the addressing mode being a stress test mode;
a mapper for modifying the sequential addresses in response to the addressing mode being a stress test mode, the modifying including swapping bits in a sequential address with other bits in the sequential address to target selected portions of a memory; and
a transmitter for outputting the modified sequential addresses to the memory, the modified sequential addresses to be utilized in a MCBIST stress test of the memory.
